(19) United States
(12) Patent Application Publication
(10) Pub. No.: US 2016/0313529 A1
(43) Pub. Date: Oct. 27, 2016

(54) FILLER TUBES FOR OPTICAL COMMUNICATION CABLE CONSTRUCTION

(71) Applicant: Corning Optical Communications LLC, Hickory, NC (US)

(72) Inventors: James Lee Baucom, Conover, NC (US); Leigh Rooker Josey, Hickory, NC (US); Christopher Mark Quinn, Hickory, NC (US); David Alan Seddon, Hickory, NC (US); Kimberly Wilbert Smith, Hickory, NC (US); Catharina Lemckert Tedder, Catawba, NC (US)

(21) Appl. No.: 15/131,158

(22) Filed: Apr. 18, 2016

Related U.S. Application Data
(60) Provisional application No. 62/151,724, filed on Apr. 23, 2015.

(51) Int. Cl. G02B 6/44

(52) U.S. Cl. CPC G02B 6/4494; G02B 6/443; G02B 6/4434; G02B 6/441; G02B 6/4483

(57) ABSTRACT

An optical communication cable includes a central strength member, at least one optical fiber, a buffer tube surrounding the at least one optical fiber; and at least one non-solid filler tube defining a cavity, wherein the cavity contains a water-blocking component and no optical fibers, and wherein the buffer tube and the filler tube are stranded about the central strength member.

### CROSS-REFERENCE TO RELATED APPLICATIONS

This application claims the benefit of priority to U.S. Provisional Application No. 62/151,724, filed on Apr. 23, 2015, and is incorporated herein by reference.

### BACKGROUND

The disclosure relates generally to materials for the manufacture of fiber optic communication cables and more specifically to the use of non-solid filler tubes in the construction of an optical fiber communication cable. Historically, solid filler rods have been used for stranded cable designs when not all of the buffer tube positions in an optical cable are needed. Conventional rods may be formed from a solid or foamed polyethylene (PE) material to have the same diameter along the longitudinal length of the rod as the live tubes they are replacing. In some designs, the solid or foamed tubes may contain recycled or reground PE.

Advances in the construction of optical communication cables are driving new approaches to the use of filler tubes in loose tube and/or stranded cable design. For example, maximum lengths for certain conventional loose tube cables may be around 14 km, and filler tubes or rods can be spliced into the process mid-run so that remnant scrap lengths are almost eliminated. However, binder yarns which typically hold the stranded core together are being replaced by a thin extruded layer of PE film in some cable designs and the desire for much longer production runs are driving a line that cannot now stop mid-run due to the extrusion process. These changes, along with the desire for runs up to 30 km, for example, and the inability to splice filler rods together during a run, have implications for filler rods. For optical communication cables manufactured in accordance with these new processes, it is desirable to use non-solid filler tubes formed from a material other than PE, for example, to prevent the filler tubes from sticking to the PE film. Also, because of the longer production runs and the inability to splice in fillers, order-to-length filler tubes may be preferable in the construction of cables having buffer tubes that are sometimes replaced by filler rods due to fiber counts or fiber placement not requiring use of all the live positions in the cable.

### SUMMARY

Aspects of the present disclosure relates to an optical fiber communication cable that includes at least one non-solid filler tube to replace the solid rods conventionally used as fillers in stranded cable designs. The filler tube may be formed from a polypropylene (PP) compound. However, any other plastic including PE, polycarbonate (PC), polybutylene terephthalate (PBT), etc. may be used depending on requirements of other stranded cable products.

In accordance with other aspects of the present disclosure, an optical communication cable may include a central strength member, at least one optical fiber, a buffer tube surrounding the at least one optical fiber, and at least one non-solid filler tube defining a cavity, wherein the cavity contains a water-blocking component and no optical fibers, and wherein the buffer tube and the filler tube are stranded about the central strength member.

In accordance with yet other aspects of the present disclosure, a method of manufacturing an optical communication cable comprises extruding a filler tube from a plastic compound using a tip and die to define a cavity by generating an annular cross section having an inner diameter and an outer diameter, feeding a water blocking component into the cavity through a crosshead in the tip, and stranding the filler tube containing no optical fibers with at least one other core element around a central strength element.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view of an optical fiber cable, in accordance with aspects of the present disclosure;

FIG. 2 is a cross-sectional view of a non-solid filler tube, in accordance with aspects of the present disclosure;

FIG. 3 is a table illustrating the effects of thermal cycling on twelve fiber gel free loose tube cables having solid and non-solid filler components, in accordance with aspects of the present disclosure; and

FIG. 4 is a chart illustrating cable integrity during installation of twelve fiber gel free loose tube cables having solid and non-solid filler components, in accordance with aspects of the present disclosure.

### DETAILED DESCRIPTION

Referring generally to the figures, various embodiments of an arrangement of storing fiber optic filler tubes are shown. In general, many fiber optic cables include one or more buffer tubes, for example loose buffer tubes. The buffer tubes typically are a hollow thermoplastic tube with a central bore that contains one or more optical fibers and stranded around a central strength member. In some embodiments, one or more buffer tubes may not need to include optical fibers. However, to maintain the shape of the cable and the mechanical properties of the cable, filler tubes in accordance with aspects of this invention may be used in the place of those buffer tubes that would otherwise be empty. Following stranding of the buffer tubes and the filler tubes, additional layers (e.g., binders, water block tape, armor layers) may be formed around the stranded buffer tubes and finally a cable jacket is applied to the cable. Cable formation is a continuous process in which buffer tubes are drawn or paid out as the buffer tubes or filler tubes are wrapped around a central strength member in a stranding pattern. In some embodiments, the stranded buffer tubes or filler tubes may be taken up and stored on a reel prior to application of additional outer cable layers, such as an armor layer, water block layers and cable jacket.

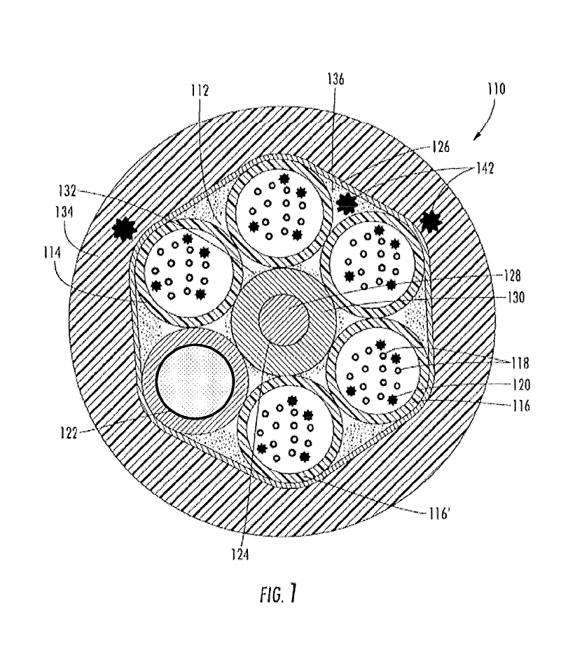

Referring to FIG. 1, a cable in the form of a fiber optic cable 110 may be an outside-plant loose tube cable, an indoor cable with fire-resistant/retardant properties, an indoor/outdoor cable, or another type of cable, such as a datacenter interconnect cable with micro-modules or a hybrid fiber optic cable including conductive elements. According to an exemplary embodiment, the cable 110 includes a core 112 (e.g., sub-assembly, micro-module), which may be located in the center of the cable 110 or elsewhere and may be the only core of the cable 110 or one of several cores. According to an exemplary embodiment, the core 112 of the cable 110 includes core elements 114.

In some embodiments, the core elements 114 include a tube 116, such as a buffer tube surrounding at least one optical transmission element 118, a tight-buffer surrounding an optical fiber, or other tube. According to an exemplary embodiment, the tube 116 may contain two, four, six, twelve, twenty-four or other numbers of optical fibers 118. In contemplated embodiments, the core elements 114 additionally or alternatively include a tube 116 in the form of a dielectric insulator surrounding a conductive wire or wires, such as for a hybrid cable.

In some embodiments, the tube 116 further includes a water-blocking element, such as gel (e.g., grease, petroleum-based gel) or an absorbent polymer (e.g., super-absorbent polymer particles or powder). In some such embodiments, the tube 116 includes yarn 120 carrying (e.g., impregnated with) super-absorbent polymer, such as at least one water-blocking yarn 120, at least two such yarns, or at least four such yarns per tube 116. In other contemplated embodiments, the tube 116 includes super-absorbent polymer without a separate carrier, such as where the super-absorbent polymer is loose or attached to interior walls of the tube. In some such embodiments, particles of super-absorbent polymer are partially embedded in walls of the tube 116 (interior and/or exterior walls of the tube) or bonded thereto with an adhesive. For example, the particles of super-absorbent polymer may be pneumatically sprayed onto the tube 116 walls during extrusion of the tube 116 and embedded in the tube 116 while the tube 116 is tacky, such as from extrusion processes.

According to an exemplary embodiment, the optical fiber 118 of the tube 116 is a glass optical fiber, having a fiber optic core surrounded by a cladding (shown as a circle surrounding a dot in FIG. 1). Some such glass optical fibers may also include one or more polymeric coatings. The optical fiber 118 of the tube 116 is a single mode optical fiber in some embodiments, a multi-mode optical fiber in other embodiments, a multi-core optical fiber in still other embodiments. The optical fiber 118 may be bend resistant (e.g., bend insensitive optical fiber, such as CLEARCURVE™ optical fiber manufactured by Corning Incorporated of Corning, N.Y.). The optical fiber 118 may be color-coated and/or tight-buffered. The optical fiber 118 may be one of several optical fibers aligned and bound together in a fiber ribbon form.

According to an exemplary embodiment, the core 112 of the cable 110 includes a plurality of additional core elements (e.g., elongate elements extending lengthwise through the cable 110), in addition to the tube 116, such as at least three additional core elements, at least five additional core elements. According to an exemplary embodiment, the plurality of additional core elements includes at least one of a filler tube 122 and/or an additional tube 116′. In other contemplated embodiments, the core elements 114 may also or alternatively include straight or stranded conductive wires (e.g., copper or aluminum wires) or other elements. In some embodiments, the core elements are all about the same size and cross-sectional shape (see FIG. 1), such as all being round and having diameters of within 10% of the diameter of the largest of the core elements 114. In other embodiments, core elements 114 may vary in size and/or shape.

The cable 110 includes a binder film 126 (e.g., membrane) surrounding the core 112, exterior to some or all of the core elements 114. The tube 116 and the plurality of additional core elements 116′, 122 are at least partially constrained (i.e., held in place) and directly or indirectly bound to one another by the binder film 126. In some embodiments, the binder film 126 directly contacts the core elements 114. For example, tension T in the binder film 126 may hold the core elements 114 against a central strength member 124 and/or one another. The loading of the binder film 126 may further increase interfacial loading (e.g., friction) between the core elements 114 with respect to one another and other components of the cable 110, thereby constraining the core elements 114.

According to an exemplary embodiment, the binder film 126 includes (e.g., is formed from, is formed primarily from, has some amount of) a polymeric material such as polyethylene (e.g., low-density polyethylene, medium density polyethylene, high-density polyethylene), polypropylene, polyurethane, or other polymers. In some embodiments, the binder film 126 includes at least 70% by weight polyethylene, and may further include stabilizers, nucleation initiators, fillers, fire-retardant additives, reinforcement elements (e.g., chopped fiberglass fibers), and/or combinations of some or all such additional components or other components.

According to an exemplary embodiment, the binder film 126 is formed from a material having a Young's modulus of 3 gigapascals (GPa) or less, thereby providing a relatively high elasticity or springiness to the binder film 126 so that the binder film 126 may conform to the shape of the core elements 114 and not overly distort the core elements 114, thereby reducing the likelihood of attenuation of optical fibers 118 corresponding to the core elements 114. In other embodiments, the binder film 126 is formed from a material having a Young's modulus of 5 GPa or less, 2 GPa or less, or a different elasticity, which may not be relatively high.

According to an exemplary embodiment, the binder film 126 is thin, such as 0.5 mm or less in thickness (e.g., about 20 mil or less in thickness, where “mil” is 1/1000th inch). In some such embodiments, the film is 0.2 mm or less (e.g., about 8 mil or less), such as greater than 0.05 mm and/or less than 0.15 mm. In some embodiments, the binder film 126 is in a range of 0.4 to 6 mil in thickness, or another thickness. In contemplated embodiments, the film may be greater than 0.5 mm and/or less than 1.0 mm in thickness. In some cases, for example, the binder film 126 has roughly the thickness of a typical garbage bag. The thickness of the binder film 126 may be less than a tenth the maximum cross-sectional dimension of the cable, such as less than a twentieth, less than a fiftieth, less than a hundredth, while in other embodiments the binder film 126 may be otherwise sized relative to the cable cross-section. In some embodiments, when comparing average cross-sectional thicknesses, the jacket 134 is thicker than the binder film 126, such as at least twice as thick as the binder film 126, at least ten times as thick as the binder film 126, at least twenty times as thick as the binder film 126. In other contemplated embodiments, the jacket 134 may be thinner than the binder film 126, such as with a 0.4 mm nylon skin-layer jacket extruded over a 0.5 mm binder film.

The thickness of the binder film 126 may not be uniform around the bound stranded elements 114. As such, the “thickness” of the binder film 126, as used herein, is an average thickness around the cross-sectional periphery. Use of a relatively thin binder film 126 allows for rapid cooling of the binder film 126 during manufacturing and thereby allowing the binder film 126 to quickly hold the core elements 114 in place, such as in a particular stranding configuration, facilitating manufacturing. By contrast, cooling may be too slow to prevent movement of the stranded core elements when extruding a full or traditional jacket over the core, without binder yarns (or the binder film); or when even extruding a relatively thin film without use of a caterpuller or other assisting device. However such cables are contemplated to include coextruded access features, embedded water-swellable powder, etc. Subsequent to the application of the binder film 126, the manufacturing process may further include applying a thicker jacket 134 to the exterior of the binder film 126, thereby improving robustness and/or weather-ability of the cable 110. In other contemplated embodiments, the core 112, surrounded by the binder film 114, may be used and/or sold as a finished product.

Still referring to FIG. 1, the cable 110 further includes the central strength member 124, which may be a dielectric strength member, such as an up-jacketed glass-reinforced composite rod. In other embodiments, the central strength member 124 may be or include a steel rod, stranded steel, tensile yarn or fibers (e.g., bundled aramid), or other strengthening materials. As shown in FIG. 1, the central strength member 124 includes a center rod 128 and is up-jacketed with a polymeric material 130 (e.g., polyethylene, low-smoke zero-halogen polymer).

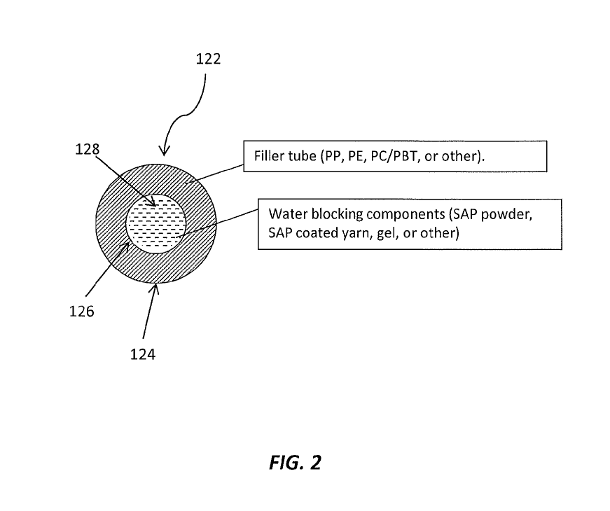

As shown in FIG. 2, the filler tube 122 in accordance with aspects of the present disclosure may be a non-solid tube having an outer diameter 124 defined by the live tube which it is replacing. The tube inner diameter 126 should provide a wall thickness which provides sufficient crush strength for the filler tube. For example, for a filler tube 122 comprised of PP, 2.5 mm OD and 1.6 mm ID provides sufficient crush strength for the filler tube. The filler tube 122 may be comprised of PP, PE, PC/PBT, or any other suitable polymer material to provide the mechanical properties necessary. The tube wall defines an inner cavity 128 that may be filled with water blocking components, such as SAP powder, SAP coated yarn, gel or other suitable water blocking components.

The filler tube 122 may be manufactured by extruding the desired plastic compound compatible with the relevant cable design (PE, PP, PC, PBT, or any other suitable plastic, or combination of plastics) using a tip and die to generate an annular cross section with the desired dimensions. The water blocking component may be fed through the crosshead inside the tip. A yarn may be fed into the process through the crosshead. SAP powder may be blown in to the tip through the crosshead (process covered by existing Corning patent), or water blocking gel may be pumped into the cross head.

The extrusion line process parameters should be established to minimize post extrusion shrinkage in the filler tube, and to maintain the desired round geometry. For example the filler tube 122 must be sufficiently cooled by water trough or other cooling mechanism before being exposed to sheaves or other equipment touch points such that the tube is in tolerance for diameter and ovality. In addition the cooling rate after the extruder and before the take-up must be provided to control shrinkage of the tube after extrusion within desired specifications.

A cable with filler tubes such as that shown in FIGS. 1-2 has better attenuation performance at low temperatures than does a cable with filler rods. Thermal expansion coefficient for a cable design can be estimated by the equation:

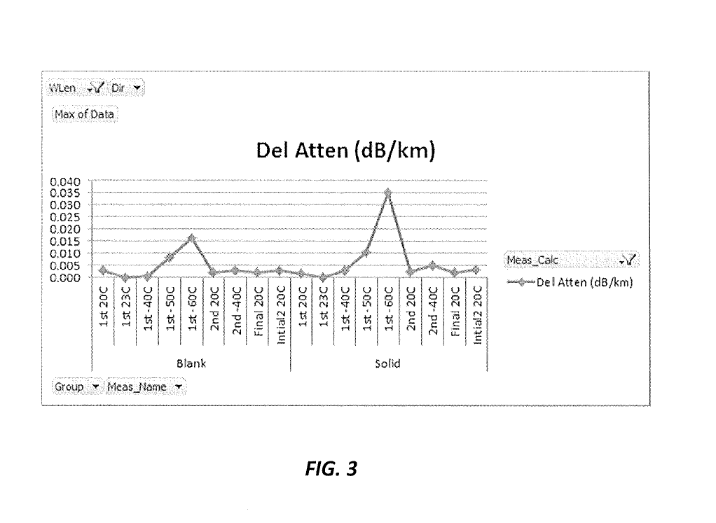

α_{eff}=Σ EᵢAᵢαᵢ/Σ EᵢAᵢ,

where E is modulus, A is cross sectional area, and α is the coefficient of thermal expansion, and the summations are made across all the elements in the cable design. A cable design with non-solid filler tubes compared to a design with solid rods will have a comparatively lower α_{eff} due to less cross sectional area of these elements, and it will therefore contract less at low temperatures. An experiment was run to confirm this benefit of filler tubes (blank tubes) compared to solid rods. FIG. 3 is a table illustrating a comparison of 12 fiber gel free loose tube cable performance at 1550 nm.

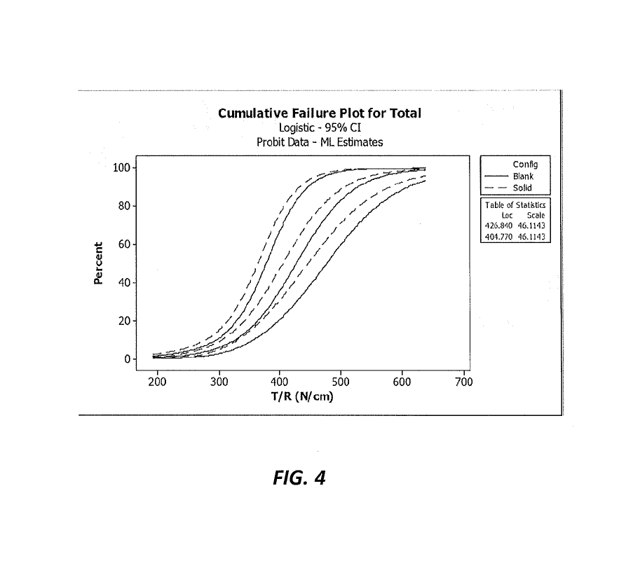

The cable integrity during installation may be improved as a result of using the non-solid filler tubes 122 in the cable. A cable test, sometimes referred to as the Wringer test, has been devised to simulate extreme tension and bend radius conditions which a cable may be exposed to during installation. As shown in FIG. 4, various loads are applied to a cable as it is respooled across a variety of sheave sizes. The cables are then measured for fiber breaks. A probability curve of fiber breaks across various T/r (tension over radius) levels is generated. Cable testing was performed on the same 12 fiber cables discussed above and shown in FIG. 3. Wringer performance in the cable with the non-solid filler tubes 122 was better than in the cable with the solid rods. As illustrated in FIG. 4, the rigid, solid rods create more localized stresses when load is applied at increasingly small diameters which results in more broken fibers.

Today, many filler rods are foamed to decrease the amount of plastic material required, and thus reduce the cost of the filler. In addition, some manufacturers will use a percentage of regrind or recycled material to lower the cost of the filler rod. By moving to a non-solid, non-foamed filler tube 122 with water blocking components, the required amount of plastic can be further reduced resulting in significant material cost savings. Some water blocking components such as super absorbent polymer (SAP), or a yarn coated with SAP are inexpensive relative to the plastic compound, and so filling the void with one of these materials is a cheaper alternative than a solid foamed rod, and much cheaper than a solid non-foamed rod.

While the specific cable embodiments discussed herein and shown in the figures relate primarily to cables and core elements that have a substantially circular cross-sectional shape defining substantially cylindrical internal bores, in other embodiments, the cables and core elements discussed herein may have any number of cross-section shapes.

The optical transmission elements discussed herein include optical fibers that may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate and chalcogenide glasses, as well as crystalline materials such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical communication cable comprising:
a central strength member;
a plurality of core elements stranded about the strength member, wherein the plurality of core elements includes at least one non-solid filler tube defining a cavity, the cavity containing a water-blocking component and no optical fibers.

2. The optical communication cable of claim 1, wherein the plurality of core elements further includes at least one buffer tube, the at least one buffer tube surrounding at least one optical transmission element.

3. The optical communication cable of claim 1, wherein the water-blocking component is a gel, a super-absorbent polymer powder, or a super-absorbent polymer yarn.

4. The optical communication cable of claim 1, wherein each core element of the plurality of core elements has an outside diameter within 10% of an outside diameter of each other core element in the plurality of core elements.

5. The optical communication cable of claim 1, wherein a binder film surrounds the plurality of core elements such that each core element is at least partially constrained and directly or indirectly bound to each other core element by the binder film.

6. The optical communication cable of claim 1, wherein the filler tube comprises a wall having an inner diameter of at least 1.6 millimeters and an outer diameter of at least 2.5 millimeters.

7. The optical communication cable of claim 1, wherein the filler tube is an extruded polymer tube that comprises polypropylene, polyethylene, polycarbonate, or polybutylene terephthalate.

8. The optical communication cable of claim 1, wherein the central strength member is up-jacketed with a polymeric material.

9. The optical communication cable of claim 8, wherein the central strength member is dielectric.

10. The optical communication cable of claim 9, wherein the central strength member is a glass-reinforced composite rod.

11. A method of manufacturing an optical communication cable comprising:
extruding a filler tube from a plastic compound using a tip and die to define a cavity by generating an annular cross section having an inner diameter and an outer diameter;
feeding a water blocking component into the cavity through a crosshead in the tip; and
stranding the filler tube containing no optical fibers with at least one other core element around a central strength element.

12. The method of claim 11, wherein the at least one other core element includes at least one buffer tube, the method further comprising providing at least one optical transmission element in the at least one buffer tube.

13. The method of claim 11, wherein the water-blocking component is a gel, a super-absorbent polymer powder, or a super-absorbent polymer yarn.

14. The method of claim 11, further comprising forming the filler tube such that the outer diameter is sized to be within 10% of an outside diameter of the at least one other core element.

15. The method of claim 11, further comprising surrounding the stranded filler tube and the at least one other core element with a binder film such that the stranded filler tube and the at least one other core element are at least partially constrained and bound by the binder film.

16. The method of claim 11, wherein the inner diameter of the filler tube is at least 1.6 millimeters and the outer diameter of the filler tube is at least 2.5 millimeters.

17. The method of claim 11, wherein the plastic compound comprises polypropylene, polyethylene, polycarbonate, or polybutylene terephthalate.

18. The method of claim 11, further comprising up jacketing the central strength member with a polymeric material.

19. The method of claim 18, wherein the central strength member is dielectric.

20. The method of claim 19, wherein the central strength member is a glass-reinforced composite rod.
